(19) United States
(12) Patent Application Publication
(10) Pub. No.: US 2024/0194002 A1
(43) Pub. Date: Jun. 13, 2024

(54) Method for Itemizing Mixed Diagnostic Codes

(71) Applicant: Robert Bosch GmbH, Stuttgart (DE)

(72) Inventors: Charles Lee Murphy, Forsyth, GA (US); Adam Kilanowski, Fairbault, MN (US); Abhishek Pradhan, Lakeville, MN (US)

(21) Appl. No.: 18/521,298

(22) Filed: Nov. 28, 2023

Related U.S. Application Data
(60) Provisional application No. 63/430,836, filed on Dec. 7, 2022.

(51) Int. Cl. G07C 5/00; G07C 5/08

(52) U.S. Cl. CPC G07C 5/008; G07C 5/0808; G07C 5/0825; G07C 2205/02

(57) ABSTRACT

A method for acquiring diagnostic data from a vehicle communication interface and providing the data to a user of a diagnostic tool as an itemized list. The diagnostic data comprises mixed types, such as diagnostic trouble codes and parameter identifiers. The user may utilize the diagnostic tool to filter or sort the diagnostic data according to elements associated with each entry of diagnostic data in an itemized list.

### TECHNICAL FIELD

This disclosure relates to diagnostic hardware and software used for servicing vehicles.

### BACKGROUND

Modern vehicles comprise a number of electronic components including sensors, controllers, and processors that are subject to service, including regular maintenance, calibration, or replacement in the event of damage or failure. Maintaining these electronic components is conventionally accomplished via a diagnostic tool that is in data communication with a vehicle communication interface (VCI) of the vehicle subject to service. The VCI is capable of providing diagnostic information to the diagnostic tool, and the diagnostic information is utilized to diagnose and service the vehicle.

Some vehicle manufacturers utilize a combination of different forms of diagnostic data to relay information to a diagnostic tool. While diagnostic trouble codes (DTCs) are most common, other types of data may be utilized for some vehicle makes and models. What is desired is a diagnostic tool that can acquire and present all relevant forms of diagnostic data in a cohesive presentation for a user to efficiently service the vehicle.

### SUMMARY

One aspect of this disclosure is directed to a method for a diagnostic tool. The method comprises establishing a data connection with a vehicle communication interface (VCI) of a vehicle in communication with a vehicle processor. The method further comprises requesting diagnostic data from the VCI, the diagnostic data indicating functional conditions of the vehicle. The method further comprises receiving the diagnostic data from the VCI in response to the request. The method further comprises populating an itemized list of the diagnostic data, each entry of the itemized list including at least a component identifier, a condition element of the associated identified component, and a datum type of the entry. The method additionally comprises outputting the itemized list using a human-user interface (HMI) of the diagnostic tool. In this method, the diagnostic data indicates the functional conditions of the vehicle using diagnostic trouble codes (DTCs) and parameter identifiers (PIDs).

Another aspect of this disclosure is directed to a non-transitory computer-readable medium having stored thereon instructions that when executed by a processor cause the processor to perform a method. The method comprises establishing a data connection with a vehicle communication interface (VCI) of a vehicle in communication with a vehicle processor. The method further comprises requesting diagnostic data from the VCI, the diagnostic data indicating functional conditions of the vehicle. The method further comprises receiving the diagnostic data from the VCI in response to the request. The method further comprises populating an itemized list of the diagnostic data, each entry of the itemized list including at least a component identifier, a condition element of the associated identified component, and a datum type of the entry. The method additionally comprises outputting the itemized list using a human-user interface (HMI) of the diagnostic tool. In this method, the diagnostic data indicates the functional conditions of the vehicle using diagnostic trouble codes (DTCs) and parameter identifiers (PIDs).

The above aspects of this disclosure and other aspects will be explained in greater detail below with reference to the attached drawings.

### BRIEF DESCRIPTION OF THE DRAWINGS

FIG. 1 is an illustration of a diagnostic tool in data communication with a vehicle under service.

FIG. 2 is a flowchart illustrating a method of acquiring and itemizing diagnostic data from a vehicle under service.

FIG. 3 is an illustration of a diagnostic tool in a state of operation.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

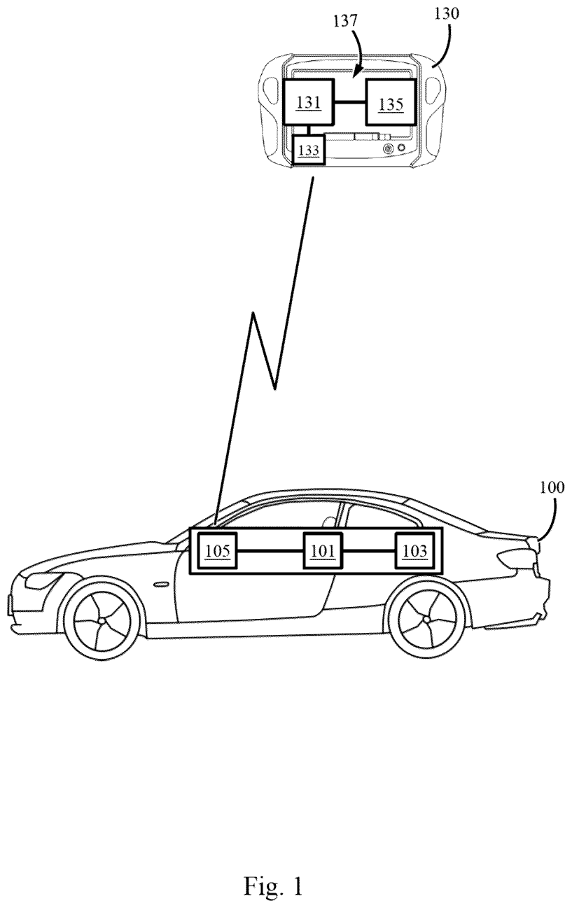

FIG. 1 shows a vehicle 100 being subject to service. Vehicle 100 comprises a vehicle processor 101, a vehicle memory 103, and a vehicle communication interface (VCI) 105. Each of the components of the vehicle 100 are in data communication via an internal bus, such as a controller-area network (CAN) bus, but other embodiments may comprise other configurations without deviating from the teachings disclosed herein. Vehicle processor 101 is also in data communication with electronic components of vehicle 100, such as controllers, electronic control units (ECUs), sensors, or processors (not shown). Using this data communication, vehicle processor 101 monitors the status of each of the electronic components and can generate diagnostic data indicating the status of each electronic component. In the depicted embodiment, vehicle processor 101 can generate diagnostic data using codes or other identifiers stored in vehicle memory 103.

VCI 105 is in data communication with diagnostic tool 130. Diagnostic tool 130 comprises a tool processor 131, a tool memory 133, a transceiver 133, and a human-machine interface (HMI) 137. In the depicted embodiment, HMI 137 comprises a touchscreen display and a number of buttons, but other embodiments may comprise other configurations without deviating from the teachings disclosed herein.

Tool processor 131 communicates with VCI 105 via transceiver 133. In the depicted embodiment, transceiver 133 comprises a transceiver configured for wireless data communication, but other embodiments may comprise other configurations without deviating from the teachings disclosed herein. Transceiver 133 may be configured to communicate wirelessly via one or more of an RF (radio frequency) specification, cellular phone channels (analog or digital), cellular data channels, a Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art. In some embodiments, transceiver 133 may be configured to support wired communication without deviating from the teachings disclosed herein. In such embodiments, transceiver 133 may support a TCP/IP connection, a local area network (LAN) connection, a plain-old-telephone-service (POTS) connection, an Internet protocol connection, an electrical wiring, a conductive channel, an electrical bus, a fiber optic pathway, or any other alternative embodiment known to one of ordinary skill in the art.

During service of vehicle 100, diagnostic tool 130 acquires identification data indicating significant identifiers for vehicle 100 from VCI 105 indicating the functional conditions of the vehicle 100. The identification data may comprise data identifying the hardware features of vehicle 100 such as a make, model, year of manufacture, vehicle identification number (VIN), or physical specifications for vehicle processor 101, vehicle memory 103, or other electronic components of vehicle 100. The identification data may comprise data identifying firmware or software features of vehicle 100, such as operating system and version for vehicle processor 101, a description of contents of vehicle memory 103, the protocol and version for the internal bus of vehicle 100, or communications protocols used by electronic components of vehicle 100.

During service of vehicle 100, diagnostic tool 130 acquires diagnostic data indicating functional conditions of the vehicle. Diagnostic data frequently takes the form of a trouble code, such as a diagnostic trouble code (DTC), but other forms of data may be utilized without deviating from the teachings disclosed herein. In the depicted embodiment, diagnostic data additionally comes in the form of parameter identifiers (PIDs) which differ from DTCs in that they indicate a status or condition of a component of vehicle 100, but do not necessarily indicate a need for service or replacement of the associated component. However, some manufacturers may utilize PIDs in order to indicate a non-functional or other status of a component requiring service.

By way of example, and not limitation, a manufacturer may utilize PIDs to indicate the status of airbag modules and associated modules. In such embodiments, PIDs may be utilized because airbag modules are known to require resetting or replacement in the event that the associated airbag has been deployed. Because a deployed airbag cannot be serviced, and must be replaced with a fresh airbag, a PID may be utilized to indicate this status. Additionally, airbag controllers responsible for firing an airbag may be expected to require replacement after being subjected to the forces of a deployed airbag (or to the forces of a collision which triggers the associated airbag to deploy). For this reason, airbag modules may utilize PIDs instead of DTCs to indicate their associated static condition. Other systems may utilize PIDs in a similar manner without deviating from the teachings disclosed herein.

In order to assist a user in determining all of the diagnostic data has been addressed, individual elements of the diagnostic data may comprise a flag or other indicator representing the current functional status of the associated component. This flag may be associated with DTCs, PIDs, or any other sort of diagnostic data indicating the functional condition of one or more components or systems of vehicle 100. In the depicted embodiment, a system-wide flag may be present to indicate that at least one component or system still requires service. In the depicted embodiment, diagnostic tool 130 utilizes the identification data in coordination with the diagnostic data in order to properly provide context for the received diagnostic data for presentation to the user.

In order to assist the user in properly servicing all the components and systems of vehicle 100, diagnostic tool 130 may organize the received diagnostic data according to associated component or system, severity, data type, flag status, or any other element of the diagnostic data recognized by one of ordinary skill in the art. This organized data may then be stored in tool memory 135 or presented to the user via HMI 137. When presented to the user, the status of the data may be updated via HMI 137 in response to the user completing service operations for the components or systems of vehicle 100 in real time. In some embodiments, the status of the diagnostic data may be refreshed at regular intervals of time to ensure that a user has an accurate representation of the functional status of vehicle 100.

Advantageously, the organized list of data may be presented as a collated and combined itemized list to the user, which provides the user with a “master list” of all conditions that warrant servicing. This itemized list may comprise any DTCs, PIDs, or any other types of diagnostic data generated by vehicle processor 101 indicating a need for service. The itemized list may be presented to the user and sortable according to user preference. The itemized list may be presented to the user according to a filter selected by the user. Sorting and filtering of the itemized list may be accomplished based upon component identifiers identifying a component or system associated with an entry of the itemized list, condition elements indicating the flag status of the associated entry of the itemized list, datum types of each entry of the itemized list indicating the data type (e.g., DTC, PID, etc.) of the entry in the list, or any other diagnostic data component recognized by one of ordinary skill in the art without deviating from the teachings disclosed herein.

In the depicted embodiment, diagnostic tool 130 is embodied as a specialized tablet processing device. In other embodiments diagnostic tool 130 may be embodied as a mobile processing device, a smartphone, a general-purpose tablet computer, a laptop computer, a wearable computing device, a desktop computer, a personal digital assistant (PDA) device, a handheld processor device, a specialized processor device, a system of processors distributed across a network, a system of processors configured in wired or wireless communication, or any other alternative embodiment known to one of ordinary skill in the art.

With further respect to tool memory 133, this memory may be embodied as a non-transitory computer-readable storage medium or a machine-readable medium for carrying or having computer-executable instructions or data structures stored thereon. Such non-transitory computer-readable storage media or machine-readable medium may be any available media embodied in a hardware or physical form that can be accessed by a general purpose or special purpose computer. By way of example, and not limitation, such non-transitory computer-readable storage media or machine-readable medium may comprise random-access memory (RAM), read-only memory (ROM), electrically erasable programmable read-only memory (EEPROM), optical disc storage, magnetic disk storage, linear magnetic data storage, magnetic storage devices, flash memory, or any other medium which can be used to carry or store desired program code means in the form of computer-executable instructions or data structures. Combinations of the above should also be included within the scope of the non-transitory computer-readable storage media or machine-readable medium.

Computer-executable data may include instructions and other data which cause a general-purpose computer, special purpose computer, or special purpose processing device to perform a certain function or group of functions. Computer-executable data may also include program modules that are executed by computers in stand-alone or network environments. Program modules may include routines, programs, objects, components, or data structures that perform particular tasks or implement particular abstract data types. Computer-executable data, associated data structures, and program modules represent examples of the program code means for executing steps of the methods disclosed herein. The particular sequence of such executable instructions or associated data structures represents examples of corresponding acts for implementing the functions described in such steps. In the depicted embodiment, the compute-executable data comprises computer-readable instructions that may be executed by the processor of a diagnostic tool (such as tool processor 131), but other embodiments may comprise other configurations without deviating from the teachings disclosed herein.

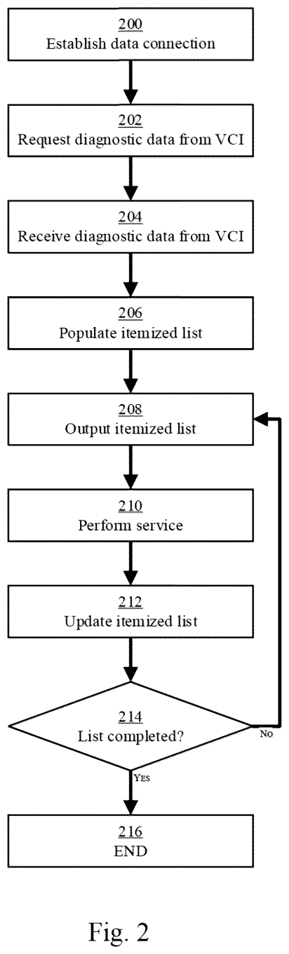

FIG. 2 is a flowchart illustrating a method of preparing an itemized list of service actions for a user to complete with respect to a vehicle (such as vehicle 100; see FIG. 1). In the depicted embodiment, this method is performed by a processor (such as tool processor 131; sec FIG. 1) of a diagnostic tool (such as diagnostic tool 130; see FIG. 1) executing computer-readable instructions stored on a non-transitory memory (such as tool memory 133; see FIG. 1), but other embodiments may comprise other implementations without deviating from the teachings disclosed herein.

The method begins at step 200, where a data connection is established to provide data communication between the vehicle and the diagnostic tool. This data connection is accomplished via a vehicle communication interface (VCI) of the vehicle (such as VCI 135; see FIG. 1). After the data connection is established and data communication begins, the diagnostic tool proceeds to step 202 and requests diagnostic data from the VCI. In some embodiments, step 202 may also comprise the diagnostic tool requesting identification data from the VCI without deviating from the teachings disclosed herein. After the request is made, the method proceeds to step 204 when the diagnostic tool receives the requested diagnostic data (and in some implementations the requested identification data). When the data has been received, the method proceeds to step 206 where the diagnostic tool populates an itemized list of the diagnostic data, the itemized list comprising a number of entries associated with conditions of the vehicle under service. This itemized list comprises a combination of all data types provided in the diagnostic data by the VCI, including DTCs and PIDs, collected into a singular itemized list that may be sorted, filtered, and navigated by the user. The itemized list is then output to the user in step 208 utilizing a human-machine interface (HMI) of the diagnostic tool. In the depicted embodiment, the HMI may comprise a touchscreen display, but other implementations of the method may utilize other HMI outputs such as projectors, electronic displays, audible outputs, haptic outputs, or any other HMI recognized by one of ordinary skill without deviating from the teachings disclosed herein.

After the itemized list is output at step 208, the diagnostic tool proceeds to step 210 and waits for an input that a service has been performed for the vehicle. This input may be input manually by the user, or may be reflected in data received from the VCI without deviating from the teachings disclosed herein.

In response to performance of the service or receipt of an indication of a completed service action, the method proceeds to step 212, where the diagnostic tool updates the itemized list to reflect the current functional status of the vehicle. This update may made directly to the already-acquired diagnostic data, but in some embodiments the diagnostic tool may make an additional request and receipt of diagnostic data from the VCI (not depicted) similar to steps 202 and 204 before proceeding. After the itemized list has been updated, the method continues to step 214 where the diagnostic tool checks to see if any entries of the itemized list remain unaddressed during service. If the entire list has been addressed, then the list of service actions has been completed, and the method proceeds to end at step 216. Otherwise, the method returns to step 208 and continues with the outputting of the updated itemized list. This service loop continues until the user has addressed every entry within the itemized list.

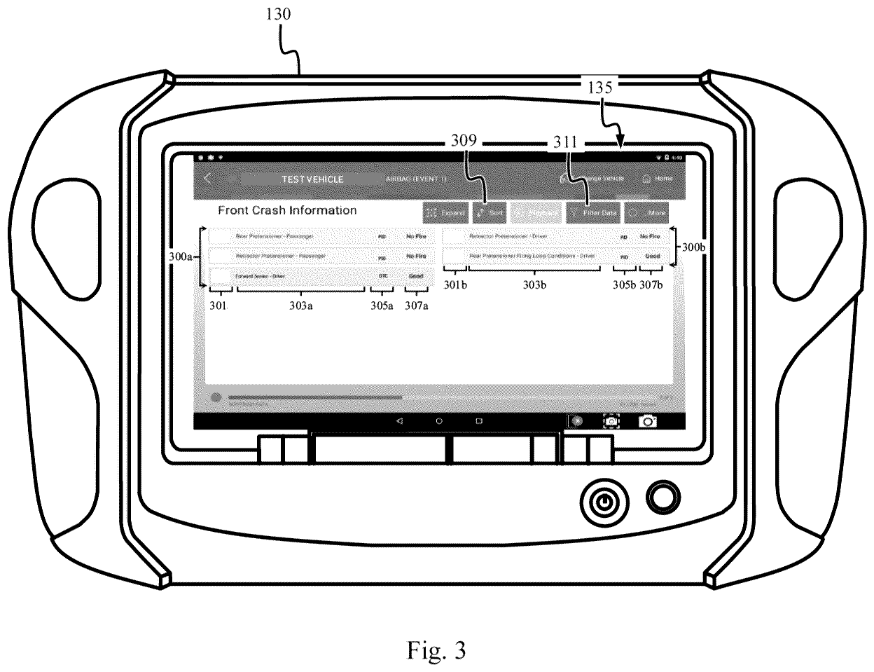

FIG. 3 is an illustration of a diagnostic tool 130 outputting on its HMI 135 an itemized list according to one embodiment of the teachings disclosed herein. In the depicted embodiment, the display provides to the user a visual output depicting a number of entries 300 of the itemized list. Each of the entries 300 is displayed with a number of values associated with the entries. These values may be filtered or sorted based upon the user's desired presentation of the data. In the depicted embodiment, each entry of the itemized list comprises a condition element 301, a component identifier 303, a datum type 305, and status indicator 307.

Condition elements 301 in the depicted embodiment comprise a “checkbox” style indicator providing a user with an indication regarding whether or not the associated entry 300 has been subjected to an appropriate service action. If the entry has been addressed, the checkbox can be filled appropriately to indicate to the user that no further action is required.

Component identifier 303 of each entry indicates to the user the particular component of the vehicle subject to service that corresponds to the entry. Component identifiers 303 can indicate any component of the vehicle that can be described by the diagnostic data including, but not limited to, controllers, electronic control units (ECUs), operational modules, sensors, processors, sub-processors, systems, sub-systems, or any other diagnosable condition of the vehicle known to one of ordinary skill without deviating from the teachings disclosed herein.

Datum type 305 of each entry indicates to a user the type of diagnostic data that the entry corresponds to. In the depicted embodiment, the types of data represented in the itemized list include “DTC” indicating a diagnostic trouble code (DTC), or “PID” indicating a parameter indicator (PID). Other embodiments may comprise other datum types without deviating from the teachings disclosed herein.

Status indicator 307 provides an indication of the current functional status of the component associated with each entry. The status indicator 307 of each entry can provide a user a short-hand indication of the type of service that is required to address the associated entry 300 of the itemized list.

In the depicted embodiment, the itemized list is displayed in two columns of entries, with entries 300a populating a first column and entries 300b populating a second column. In this depiction, the entries 300 of each column comprise identical elements, and are arranged in this manner to provide more data to the user in the limited display screen space of HMI 137. Other embodiments may comprise a different arrangement without deviating from the teachings disclosed herein. In some embodiments, different columns of the displayed itemized list may correspond to different element values. By way of example, and not limitation, the itemized list may be separated into two columns by datum type, with a first column presenting DTC entries and a second column presenting PID entries. Other configurations may be achieved according to user designation utilizing native functions to control the display of diagnostic tool 130.

In the depicted embodiment, some of these display preferences are accessible using on-screen touch buttons. In the depicted embodiment, these on-screen touch buttons comprise a sort button 309 and a filter button 311. Sort button 309 permits a user to access controls of diagnostic tool 130 that adjust the arrangement and order of the entries 300 on HMI 135. Filter button 311 permits a user to access controls of diagnostic tool 130 that selectively displays some entries 300 of the complete itemized list according to values of the elements of the entries 300. Other functions of touch buttons may be accessed without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

1. A method for a diagnostic tool comprising:
establishing a data connection with a vehicle communication interface (VCI) of a vehicle in communication with a vehicle processor;
requesting diagnostic data from the VCI, the diagnostic data indicating functional conditions of the vehicle;
receiving the diagnostic data from the VCI in response to the request;
populating an itemized list of the diagnostic data, each entry of the itemized list including at least a component identifier, a condition element of the associated identified component, and a datum type of the entry; and
outputting the itemized list using a human-user interface (HMI) of the diagnostic tool,
wherein the diagnostic data indicates the functional conditions of the vehicle using diagnostic trouble codes (DTCs) and parameter identifiers (PIDs).

2. The method of claim 1, wherein the HMI comprises a display.

3. The method of claim 1, wherein the diagnostic data includes a first PID that indicates a deployment status of an airbag.

4. The method of claim 3, wherein the diagnostic data includes at least one DTC or PID that corresponds to a functional condition of an electronic control unit (ECU) that controls the deployment of the airbag associated with the first PID.

5. The method of claim 1, further comprising:
updating the diagnostic data in response to a change in the functional condition of the vehicle; and
updating the itemized list in response to the change in the functional condition of the vehicle.

6. The method of claim 1, further comprising:
selectively outputting a filtered version of the itemized list in response to a request from a user via the HMI, the itemized list being filterable based upon the value of at least one of component identifiers, condition elements, or datum types of each of the entries in the itemized list.

7. A non-transitory computer-readable medium having stored thereon instructions that when executed by a processor cause the processor to perform a method comprising:
establishing a data connection with a vehicle communication interface (VCI) of a vehicle in communication with a vehicle processor;
requesting diagnostic data from the VCI, the diagnostic data indicating functional conditions of the vehicle;
receiving the diagnostic data from the VCI in response to the request;
populating an itemized list of the diagnostic data, each entry of the itemized list including at least a component identifier, a condition element of the associated identified component, and a datum type of the entry; and
outputting the itemized list using a human-user interface (HMI) of the diagnostic tool,
wherein the diagnostic data indicates the functional conditions of the vehicle using diagnostic trouble codes (DTCs) and parameter identifiers (PIDs).

8. The method of claim 7, wherein the diagnostic data includes a first PID that indicates a deployment status of an airbag.

9. The non-transitory computer-readable medium of claim 8, wherein the diagnostic data includes at least one DTC or PID that corresponds to a functional condition of an electronic control unit (ECU) that controls the deployment of the airbag associated with the first PID.

10. The non-transitory computer-readable medium of claim 7, further comprising instructions stored thereon that when executed by the processor cause the processor to perform the steps of:
updating the diagnostic data in response to a change in the functional condition of the vehicle; and
updating the itemized list in response to the change in the functional condition of the vehicle.

11. The non-transitory computer-readable medium of claim 7, further comprising instructions stored thereon that when executed by the processor cause the processor to perform the steps of:
selectively outputting a filtered version of the itemized list in response to a request from a user via the HMI, the itemized list being filterable based upon the value of at least one of component identifiers, condition elements, or datum types of each of the entries in the itemized list.
